(19) United States
(12) Patent Application Publication
(10) Pub. No.: US 2006/0092465 A1
(43) Pub. Date: May 4, 2006

(54) Facsimile transmission method, medium, and apparatus

(75) Inventor: Seung-wook Hong, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/263,993

(22) Filed: Nov. 2, 2005

(30) Foreign Application Priority Data
Nov. 2, 2004 (KR) 10-2004-0088366

(51) Int. Cl. G06F 3/12

(52) U.S. Cl. 358/1.15

(57) ABSTRACT

A facsimile transmission speed setting method, medium, and apparatus. The facsimile transmission speed setting method may include transmitting a DCS signal and a Training Sequence using a transmitting fax unit that receives the DCS signal from a receiving fax unit, checking the Training Sequence at a receiving side of the receiving fax unit, and if there is no transmission error in the received Training Sequence, maintaining a current transmission speed by transmitting a CFR signal to the transmitting fax unit, checking for a transmission error in Training Sequence, and checking whether the transmission error is within a predetermined range. If the transmission error is within the predetermined range the current transmission speed is maintained by transmitting the CFR signal to the transmitting fax unit, and if the transmission error is not within the predetermined range the transmission speed is reduced by transmitting an FTT signal to the transmitting fax unit.

### CROSS-REFERENCE TO RELATED APPLICATIONS

This application claims the priority of Korean Patent Application No. 10-2004-0088366, filed on Nov. 2, 2004, in the Korean Intellectual Property Office, the disclosure of which is incorporated herein in its entirety by reference.

### BACKGROUND OF THE INVENTION

1. Field of the Invention

Embodiments of the present invention relate to a facsimile, and more particularly, to a facsimile transmission method, medium, and apparatus.

2. Description of the Related Art

A facsimile, as a data communication terminal, transmits and receives information such as a text or an image, along with being an office automation (OA) device to transmit facsimile data across a public switched telephone network (PSTN), e.g., a telephone line, from a transmitting facsimile machine (hereinafter, referred to as a transmitting fax machine) that transmits the facsimile data to a receiving facsimile machine (hereinafter, referred to as a receiving fax machine) that receives the facsimile data. Recently, communications using facsimiles have become common, with much information being interchanged using such facsimile machines. A predetermined communication protocol is needed in this regard to strictly specify an information representation format or order timing of various control information related to such communications. The protocol generally includes specifications for the establishment, maintenance, and termination of facsimile connections.

FIG. 1 illustrates a conventional facsimile data transmission/receiving protocol. As shown in FIG. 1, if a calling tone (CNG) signal is sent out, attempting to make a call from a transmitting fax machine to a receiving fax machine, the receiving fax machine sends out a called tone (CED) signal in response to the CNG signal, thereby allowing the call to be connected.

When the call is connected, the receiving fax machine transmits a digital identification signal (DIS) to the transmitting fax machine. Here, when transmitting the DIS, the receiving fax machine informs the transmitting fax machine of various information about the speed, capacity, resolution, paper size, paper type, etc., for example, of the receiving fax machine. The transmitting fax machine then transmits a digital command signal (DCS), which is a digital setup command responding to a standard capacity confirmed by the DIS, to the receiving fax machine, and then consecutively sends out a Training Sequence to the receiving fax machine.

If no transmission error is detected in the Training Sequence, the receiving fax machine, having received the Training Sequence, transmits a confirmation to receive (CFR) signal, confirming that the entire procedure for the message transmission has completed and that the message transmission may begin. If the above process is successfully performed, actual data is transmitted, and when transmission of a message has been completed, a post message procedure is performed, and then the call is released.

However, it is noted that the Training Sequence is consecutively transmitted from the receiving fax machine in response to the DCS in the following manner. The transmitting fax machine sends out the Training Sequence after consecutively modulating zero bits for 1.5 seconds for synchronization with a modem. When the receiving fax machine receives and checks the Training Sequence, even if only one bit is determined to potentially be incorrect, the receiving fax machine will determine that synchronization would not be easily maintained at the current Training speed, and the receiving fax machine then sends back a fail-to-training (FTT) signal, and the transmitting fax machine may need to request the transmitting fax machine fall back to transmitting at a slower modem speed.

Here, in this case, when the transmitting fax machine transmits the Training Sequence at 14,400 bps and the receiving fax machine receives the actual Training Sequence, if one bit thereof is determined to potentially be incorrect, the transmission proceeds at 14,400 bps, commencing through 1.5 seconds. Therefore, one bit of 14,400 bits×1.5 seconds (equaling 21,600 bits) may potentially be incorrect. However, during typical data reception, the underlying original document is usually merely a text or letter, and, even with such a potential loss of data, there would generally be no difficulty in reading the transmitted original.

In other words, even though a bit of a received Training Sequence may potentially be incorrect, communication data is hardly disrupted sufficiently to be make the underlying received document unreadable or cause the underlying communication to fail. Since in most cases the original document is a letter filled with characters, even though one or two lines of the original may be disturbed, there may still be no problem in identifying the received original document. In addition, in an error correction mode (ECM), broken data (e.g., data that is determined to potentially be incorrect) can be restored by a retransmission request and thus, this is not problematic.

Nevertheless, counter to these inventor discoveries, conventionally only faultlessness of Training is emphasized, thereby reducing the transmission speed and maintaining communications at a lower speed. This reduced transmission speed may make a user feel that the communication quality is degraded when the user uses the facsimile machine.

Consequently, a facsimile (FAX) machine or a multifunction peripheral (MFP) device generally makes communications across a PSTN. Due to communication restriction factors such as several electrical noise sources, in the above environment, communications are not made in a higher speed mode of a modem, but at a lower modem speed.

### SUMMARY OF THE INVENTION

Embodiments of the present invention provide a facsimile transmission method, medium, and apparatus by which a communication speed of a facsimile is maintained at an increased speed in a noisy environment, the total communication time is reduced, and consequently, the communication rate is increased over conventional systems.

To achieve the above an/or other aspects and advantages, embodiments of the present invention include a facsimile transmission speed setting method, including checking a transmitted Training Sequence for transmission error, and maintaining a current transmission speed if no transmission error is detected, and maintaining the current transmission speed if a detected transmission error in the Training Sequence is within a predetermined range, and reducing the current transmission speed if the detected transmission error is not within the predetermined range.

The maintaining of the current transmission speed may be accomplished through a sending of a confirmation to receive (CFR) signal from a receiving fax unit to a transmitting fax unit. Further, the reducing of the current transmission speed may be accomplished through a sending of a fail-to-training (FTT) signal from a receiving fax unit to a transmitting fax unit.

The method may further include checking whether a transmission speed resetting mode is set upon the detection of the transmission error, wherein the checking of the transmitted Training Sequence for the transmission error further includes determining whether the transmission error is within the predetermined range if the transmission speed resetting mode is set, and wherein the reducing of the current transmission speed further includes reducing the current transmission speed if the transmission speed resetting mode is not set.

The transmission speed resetting mode may be settable by a user using a user interface. Similarly, the predetermined range of the transmission error may be settable by a user using a user interface. The predetermined range of the transmission error may be expressed as an error percentage or a number of error bits.

To achieve the above an/or other aspects and advantages, embodiments of the present invention include a facsimile transmission speed setting method, including transmitting a digital command (DCS) signal and a Training Sequence from a transmitting fax unit, which receives a digital identification (DIS) signal from a receiving fax unit, maintaining a transmission speed of the transmitting fax unit at a current transmitting speed upon receipt, by the transmitting fax unit, of a transmitted confirmation to receive (CFR) signal from the receiving fax unit if the receiving fax unit detects a transmission error in the received Training Sequence is within a predetermined range, and reducing the current transmitting speed of the transmitting fax unit if the transmission error is not within the predetermined range, upon receipt of a fail-to-training (FTT) signal, by the transmitting fax unit, from the receiving fax unit.

The detection of the transmission error may further include checking whether a transmission speed resetting mode is set upon the detection of the transmission error, and reducing the current transmission speed if the transmission speed resetting mode is not set, and determining whether the transmission error is within the predetermined range if the transmission speed resetting mode is set.

The transmission speed resetting mode may be settable by a user using a user interface. The predetermined range of the transmission error may be settable by a user using a user interface. In addition, the predetermined range of the transmission error may be expressed as an error percentage or a number of error bits.

To achieve the above an/or other aspects and advantages, embodiments of the present invention include a transmission speed setting apparatus, including a Training Sequence (TS) error checking unit to receive a Training Sequence from a transmitting unit, and to check for a transmission error in the Training Sequence, a confirmation to receive (CFR) transmitting unit to transmit a CFR signal to the transmitting unit and to maintain a current transmission speed of the transmitting unit if no transmission error is detected in the Training Sequence, an error range checking unit to check whether a detected transmission error is within a predetermined range, and an error processing unit to implement a maintaining of the current transmission speed by transmitting the CFR signal to the transmitting unit if the detected transmission error is within the predetermined range, and to implement a reduction of the current transmission speed by transmitting a fail-to-training (FTT) signal to the transmitting unit.

The error range checking unit may include a transmission speed resetting mode checking portion to check whether a transmission speed resetting mode is set if the transmission error is detected, and a transmission speed resetting portion to implement the reduction in the current transmission speed if the transmission speed resetting mode is not set, and a transmission error range checking portion to perform the checking of whether the detected transmission error is within the predetermined range if the transmission speed resetting mode is set.

The apparatus may further include a user interface unit to provide a transmission speed resetting mode setting menu to set the transmission speed resetting mode by a user. The user interface unit may include an error range setting menu to set the predetermined range to be an error percentage or a number of error bits.

To achieve the above an/or other aspects and advantages, embodiments of the present invention include a medium including computer readable code to implement embodiments of the present invention.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a conventional facsimile data transmission/receiving protocol;

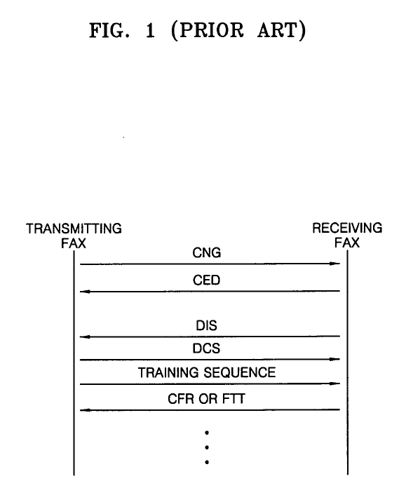

FIG. 2 illustrates a multifunction peripheral (MFP) device having a facsimile apparatus, according to an embodiment of the present invention;

FIG. 3 illustrates a facsimile transmission speed setting apparatus, according to an embodiment of the present invention;

FIG. 4 illustrates an error range checking unit, according to an embodiment of the present invention; and

FIG. 5 is a flowchart illustrating a facsimile transmission speed setting method, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

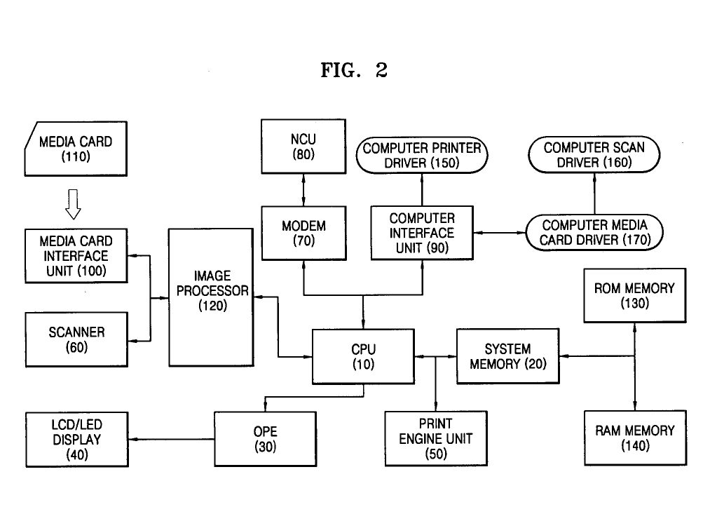

FIG. 2 illustrates a multifunction peripheral (MFP) device having a facsimile apparatus, according to an embodiment of the present invention. A central processing unit (CPU) 10 may control the MFP device according to predetermined programs, for example. As only an example, a system memory 20 may store an operating program and a normal control program of the CPU 10, and may further store data as the CPU 10 executes programs. A ROM memory 130 may be a nonvolatile memory to store the control program, and a RAM memory 140 may be a volatile memory to temporarily store data based on execution of programs and image data, for example.

A print engine unit 50 may be included and print data of the system memory 20 or print data transmitted to a host computer printer driver 150, for example. A computer interface unit 90 may transmit print data from a host computer to the print engine unit 50, thereby printing data. Here, a media card 110 may allow the host computer to manage folders of the media card 110, to read/write the media card 110, and image files through a media card interface unit 100 of the MFP device, for example.

An operating panel (OPE) 30 may be implemented and may include a plurality of keys, and may apply key data, generated when a predetermined key is pressed, to the CPU 10, to display an operating state of a system to an internal LCD/LED display 40 using display data of the CPU 10, for example. The OPE 30 may further input voice data using a microphone C-mic, with the input voice data being converted into digital data by MODEM/DSP and stored in a memory.

A scanner 60 may be included and may convert analog image data generated using an image scanning sensor into a proper format of digital image data using an image processor 120 and may store the digital image data in a memory. The media card interface unit 100 may perform a hardware interface operation on a media card, such as a smart media card, memory stick, compact flash, etc., and may controls the CPU 10, for example. When reading an image from the media card, the media card interface unit 100 may properly manipulate the image and convert the image into a proper format using the image processor 120 and then transmit the image to the host computer or the print engine unit 50 or the system memory 20, for example. A modem 70 may be implemented to send out a variety of tones and provide modulation/demodulation operations related to communications. A network control unit (NCU) 80 may be operated by control of the CPU 10, for example, and may form a calling loop of a telephone line and may interface the telephone line with the modem 70.

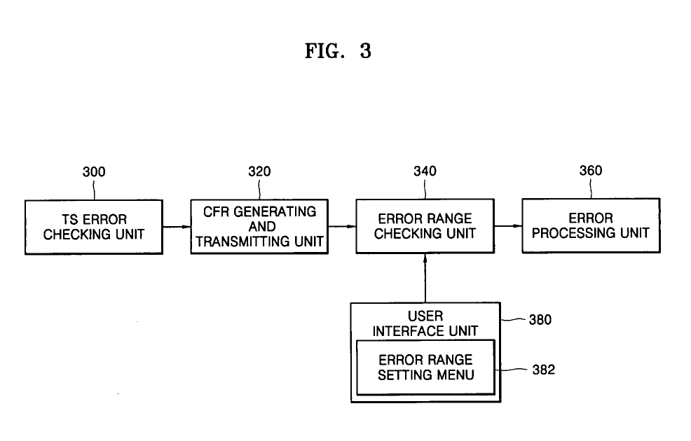

FIG. 3 illustrates a facsimile transmission speed setting apparatus, according to an embodiment of the present invention. The facsimile transmission speed setting apparatus of FIG. 3 may include a TS error checking unit 300, a CFR generating and transmitting unit 320, an error range checking unit 340, and an error processing unit 360. The facsimile transmission speed setting apparatus may further include a user interface unit, for example.

The TS error checking unit 300 may be installed at a receiving side of the facsimile unit, e.g., a facsimile module, facsimile machine, or similar functional operating medium. If a transmitting fax unit transmits a Training Sequence, the TS error checking unit 300 may receive the Training Sequence, detect the Training Sequence, and check for the transmission error. The CFR generating and transmitting unit 320 may be installed at the receiving side of the facsimile unit. If no transmission error is detected, as a checking result using the TS error checking unit 300, the CFR generating and transmitting unit 320 can maintain a current transmission speed by transmitting a CFR signal to the transmitting fax unit.

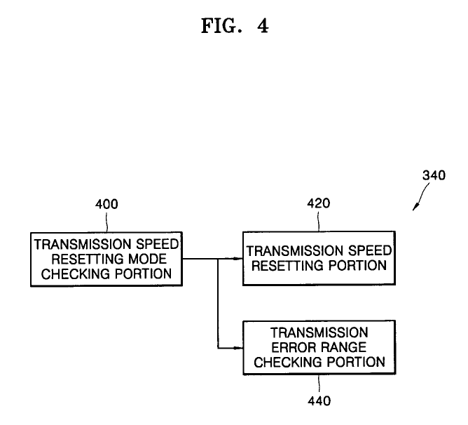

The error range checking unit 340 may be installed at the receiving side of the facsimile unit. If there is a transmission error, as the checking result using the TS error checking unit 300, the error range checking unit 340 may check whether or not the transmission error is within a predetermined range. FIG. 4 illustrates an the error range checking unit, such as the error range checking unit 340 of FIG. 3. The error range checking unit 340 of FIG. 4 may include a transmission speed resetting mode checking portion 400, a transmission speed resetting portion 420, and a transmission error range checking portion 440, for example. When the mode of the transmission speed resetting mode checking portion 400 is a transmission speed resetting mode, and if there is a transmission error detected in the checking of the received Training Sequence, the transmission speed resetting mode checking portion 400 may check whether the transmission speed resetting mode is set to “ON.” If the transmission speed resetting mode is not set to ON, the transmission speed resetting portion 420 may reduce the current transmission speed by transmitting a fail-to-training (FTT) signal to the transmitting fax unit. If the transmission speed resetting mode is set to ON, the transmission error range checking portion 440 may check whether the transmission error is within a predetermined range.

If the transmission error is within the predetermined range, the error processing unit 360 may maintain the transmission speed by transmitting the CFR signal to the transmitting fax unit. If the transmission error is not within the predetermined range, the error processing unit 360 may reduce the transmission speed by transmitting the FTT signal to the transmitting fax unit.

The facsimile transmission speed setting apparatus, according to an embodiment of the present invention, may further include a user interface unit 380. The user interface unit 380 may provide a transmission speed resetting mode setting menu for setting a transmission speed resetting mode, e.g., by a user, and may include an error range setting menu 382, for example. The error range setting menu 382 may permit the setting of a predetermined range for the transmission error to a percentage or a particular number of error bits.

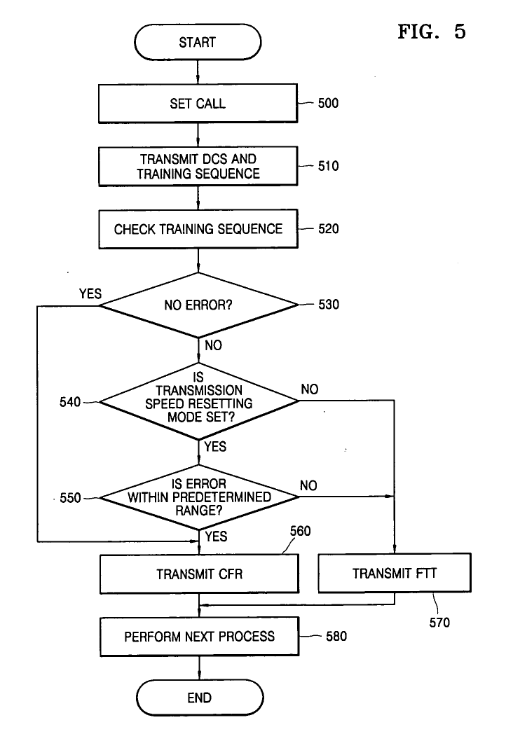

FIG. 5 is a flowchart illustrating a facsimile transmission speed setting method, according to an embodiment of the present invention. The facsimile transmission speed setting method, and the operation of the facsimile transmission speed setting apparatus, will now be described with greater detail with reference to FIG. 5.

First, as shown in FIG. 5, in operation 500, a transmitting fax unit may transmit a calling tone (CNG) signal to a receiving fax unit, and the receiving fax unit may transmit a called tone (CED) signal to the transmitting fax unit, thereby setting the call for facsimile transmission between the transmitting and receiving fax units. If call setting is completed, the receiving fax unit may then transmit a digital identification signal (DIS) to the transmitting fax unit. In this case, the receiving fax unit may further inform the transmitting fax unit of various information about speed, capacity, resolution, paper size, paper type, etc., for example, of the receiving fax unit.

In operation 510, the transmitting fax unit, which receives the DIS, may consecutively transmit a digital command signal (DCS) and Training Sequence.

In operation 520, the receiving fax unit may detect the DCS, using the TS error checking unit 300, for example, and may check for errors in the Training Sequence. In this case, if there are no transmission errors in the Training Sequence, the receiving fax unit may keep the transmission speed at the current state by transmitting a confirmation of receive (CFR) signal to the transmitting fax unit. This procedure may be performed by transmitting the CFR signal to the transmitting fax unit using the CFR generating and transmitting unit 320, for example, in operation 560.

Meanwhile, if a transmission error is determined to exist in the received Training Sequence, the receiving fax unit may then determine whether the transmission error is within a predetermined range, e.g., using the error range checking unit 340, in operation 530. If a transmission error exists in the Training Sequence, a transmission speed resetting mode is checked to see if the transmission speed resetting mode is set, e.g., using the transmission speed resetting mode checking portion 400, in operation 540.

If the transmission speed resetting mode is not set to “ON,” for example, that is, if the transmission speed resetting mode is set to OFF, a fail-to-training (FTT) signal may be transmitted to the transmitting fax unit, e.g., using the transmission speed resetting portion 420, in operation 570, the transmission speed of the transmitting fax unit may then be reduced. If the transmission speed resetting mode is set to ON, the transmission error is examined to see determine whether the transmission error is within a predetermined range, e.g., using the transmission error range checking portion 440, in operation 550.

If the transmission error is within the predetermined range, the CFR signal may be transmitted to the transmitting fax unit, using the error checking unit 360, for example, in operation 560, and the transmission speed of the transmission fax unit may be maintained at the current state for further communication, in operation 580.

If the transmission error is not within the predetermined range, the FTT signal may be transmitted to the transmitting fax unit, e.g., using the error checking unit 360, in operation 570, and further communication proceeds at a reduced transmission speed, in operation 580.

Here, in an embodiment of the present invention, the transmission speed resetting mode may be set by a user using the user interface unit 380. For example, if the transmission speed resetting mode is set to ON, and even if only one bit of the Training Sequence is determined to potentially be in error, the FTT may not be immediately be transmitted to the transmitting fax unit. In this case, an error range, indicating a permissible amount of transmission error of the Training Sequence, may be set by the user using the user interface unit 380, or may be selected by the user if the error range is given in a menu format, for example. In addition, the amount of transmission error may expressed as a percentage or according to the number of error bits. For example, the amount of the transmission error may be indicated in units of 10%, or by the number of error bits.

In the meantime, another method embodiment will now be further described. The receiving fax unit may receive the Training Sequence and check for corresponding error bits. Assuming that a predetermined error range of the Training Sequence is set to 1%, and the transmission speed of the Training Sequence of the transmitting fax unit is set to 14,400 bps, 1% corresponds to transmission proceeding at 14,400 bps for 1.5 seconds, the number of error bits would be less than 216, among 14,400×1.5 bits (equaling 21,600 bits), and if the transmission speed of the transmitting fax is 4,800 bps, the number of error bits would be less than 72 among 7,200 bits. Thus, if the receiving fax unit checks for transmission error bits in the Training Sequence, the transmission speed may be 14,400 bps and the number of transmission error bits may be less than 216, the transmitting fax unit would not need to request a transmission speed fall back due to the FTT signal but may transmit the CFR signal and then receive a fax at a current speed. In this way, the speed at which the fax is received may be determined according to an error bit allowance rate in each bandwidth. However, if the number of transmission error bits is equal to or greater than 216, the FTT signal may be transmitted, and then, a next process of reducing the transmission speed may be performed. Consequently, even though part of the Training Sequence may be damaged, e.g., by noise and attenuation, a current speed would not need to be reduced, but may be kept at a higher speed than conventional systems.

Embodiments of the invention may also be embodied as computer readable code on a medium, e.g., a computer readable recording medium. The medium may be any data storage device that can store/transmit data which can be thereafter read by a computer system, for example. Examples of the medium may include read-only memory (ROM), random-access memory (RAM), CD-ROMs, magnetic tapes, floppy disks, and optical data storage devices, for example.

As described above, in a facsimile transmission speed setting method, medium, and apparatus, according to embodiments of the present invention, even though part of a received Training Sequence may be damaged by noise and attenuation, when determining the communication speed between facsimile units, a current speed may not need to be reduced, but may be kept to the higher speed, i.e., higher than a range that previously-determined communications are not affected. As such, communications may be completed more quickly, which results in cost saving and the reduction the total communication time, thereby increasing the communication rate over other facsimile units.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A facsimile transmission speed setting method, comprising:
checking a transmitted Training Sequence for transmission error, and maintaining a current transmission speed if no transmission error is detected, and maintaining the current transmission speed if a detected transmission error in the Training Sequence is within a predetermined range; and
reducing the current transmission speed if the detected transmission error is not within the predetermined range.

2. The facsimile transmission speed setting method of claim 1, wherein the maintaining of the current transmission speed is accomplished through a sending of a confirmation to receive (CFR) signal from a receiving fax unit to a transmitting fax unit.

3. The facsimile transmission speed setting method of claim 1, wherein the reducing of the current transmission speed is accomplished through a sending of a fail-to-training (FTT) signal from a receiving fax unit to a transmitting fax unit.

4. The method of claim 1, further comprising checking whether a transmission speed resetting mode is set upon the detection of the transmission error,
wherein the checking of the transmitted Training Sequence for the transmission error further comprises determining whether the transmission error is within the predetermined range if the transmission speed resetting mode is set, and
wherein the reducing of the current transmission speed further comprises reducing the current transmission speed if the transmission speed resetting mode is not set.

5. The method of claim 4, wherein the transmission speed resetting mode is settable by a user using a user interface.

6. The method of claim 1, wherein the predetermined range of the transmission error is settable by a user using a user interface.

7. The method of claim 6, wherein the predetermined range of the transmission error is expressed as an error percentage or a number of error bits.

8. A facsimile transmission speed setting method, comprising:
transmitting a digital command (DCS) signal and a Training Sequence from a transmitting fax unit, which receives a digital identification (DIS) signal from a receiving fax unit;
maintaining a transmission speed of the transmitting fax unit at a current transmitting speed upon receipt, by the transmitting fax unit, of a transmitted confirmation to receive (CFR) signal from the receiving fax unit if the receiving fax unit detects a transmission error in the received Training Sequence is within a predetermined range; and
reducing the current transmitting speed of the transmitting fax unit if the transmission error is not within the predetermined range, upon receipt of a fail-to-training (FTT) signal, by the transmitting fax unit, from the receiving fax unit.

9. The method of claim 8, wherein the detection of the transmission error further comprises:
checking whether a transmission speed resetting mode is set upon the detection of the transmission error; and
reducing the current transmission speed if the transmission speed resetting mode is not set, and determining whether the transmission error is within the predetermined range if the transmission speed resetting mode is set.

10. The method of claim 9, wherein the transmission speed resetting mode is settable by a user using a user interface.

11. The method of claim 10, wherein the predetermined range of the transmission error is settable by a user using a user interface.

12. The method of claim 11, wherein the predetermined range of the transmission error is expressed as an error percentage or a number of error bits.

13. A transmission speed setting apparatus, comprising:
a Training Sequence (TS) error checking unit to receive a Training Sequence from a transmitting unit, and to check for a transmission error in the Training Sequence;
a confirmation to receive (CFR) transmitting unit to transmit a CFR signal to the transmitting unit and to maintain a current transmission speed of the transmitting unit if no transmission error is detected in the Training Sequence;
an error range checking unit to check whether a detected transmission error is within a predetermined range; and
an error processing unit to implement a maintaining of the current transmission speed by transmitting the CFR signal to the transmitting unit if the detected transmission error is within the predetermined range, and to implement a reduction of the current transmission speed by transmitting a fail-to-training (FTT) signal to the transmitting unit.

14. The apparatus of claim 13, wherein the error range checking unit comprises:
a transmission speed resetting mode checking portion to check whether a transmission speed resetting mode is set if the transmission error is detected; and
a transmission speed resetting portion to implement the reduction in the current transmission speed if the transmission speed resetting mode is not set; and
a transmission error range checking portion to perform the checking of whether the detected transmission error is within the predetermined range if the transmission speed resetting mode is set.

15. The apparatus of claim 14, further comprising a user interface unit to provide a transmission speed resetting mode setting menu to set the transmission speed resetting mode by a user.

16. The apparatus of claim 15, wherein the user interface unit comprises an error range setting menu to set the predetermined range to be an error percentage or a number of error bits.

17. A medium comprising computer readable code to implement the method of claim 1.

18. A medium comprising computer readable code to implement the method of claim 4.

19. A medium comprising computer readable code to implement the method of claim 8.

20. A medium comprising computer readable code to implement the method of claim 9.
